(19) United States
(12) Patent Application Publication
(10) Pub. No.: US 2005/0248067 A1
(43) Pub. Date: Nov. 10, 2005

(54) Molder for pulp, slurry, other suspensions

(76) Inventor: Ervin Geiger JR., Columbia City, IN (US)

Correspondence Address: RANDALL J. KNUTH P.C., 4921 DESOTO DRIVE, FORT WAYNE, IN, 46815, US

(21) Appl. No.: 11/106,096

(22) Filed: Apr. 14, 2005

Related U.S. Application Data
(60) Provisional application No. 60/562,015, filed on Apr. 14, 2004.

(51) Int. Cl. B29C 41/50

(52) U.S. Cl. 264/510; 264/571; 425/4 R

(57) ABSTRACT

A molding tool is especially adapted for vacuum molding or forming of structures and, in particular, fibrous composite structures in an adjustable, controllable three dimensional orientation before, during and after molding. Such a molding tool includes a mold plate with narrow slots in the mold surface thereof and wider channels in the back surface thereof, with such slots and channels intersecting one another. A control system of servomotors or other actuators permits movement and orientation of the mold forming head during forming, thereby creating the ability to vary the material properties based on gravity and particle or suspension grain, thickness and other now controllable properties.

### CROSS REFERENCES TO RELATED APPLICATIONS

This application claims priority under 35 U.S.C. 109(e) from U.S. Provisional Patent application Ser. No. 60/562,015 filed Apr. 14, 2004, which application is incorporated herein by reference.

### BACKGROUND OF THE INVENTION

1. Field of the Invention

The present invention relates generally to an apparatus and method for molding or forming items from pulp, slurries, or other suspensions. The vacuum forming head or mold plate in the apparatus is given the ability to be located in various orientations within the material holding tank, thereby creating the ability to control the influence of gravity and material properties during the forming or molding process.

2. Related Art

The forming process of items, particularly those formed from solutions of pulps, slurries or suspensions have, up to now, never had way to control the direction of gravity during the forming process. In the prior art, once the mold was set up, the direction of gravity was fixed relative to mold. Gravity effects on the suspended particles in the suspensions would, during the forming process sometimes cause non-uniform surface effects in the formed piece. What is needed in the art is a mechanism to control the orientation of the vacuum forming head relative to gravity.

### SUMMARY OF THE INVENTION

The present invention includes a molding tool system especially adapted for vacuum molding or forming of structures and, in particular, fibrous or particulate composite structures. Such a molding tool system includes a mold or mold plate able to oriented in a controlled, three dimensional fashion before, during, and after molding.

The present invention, in one form thereof, comprises a molding plate for use in a molding tool for forming a part. This molding plate includes a mold surface and a back surface. The mold surface has a shaped portion corresponding to a desired shape for the part to be formed therewith. The mold surface has a plurality of vent slots formed therein. Further, each vent slot has a corresponding slot width. The back surface is opposite the mold surface and has a plurality of channels formed therein. The channels are formed deep enough in the molding plate so as to fluidly interconnect with at least a set of the vent slots. The channels are substantially co-parallel and each have a channel width. This channel width is much greater than the slot width.

Yet an additional advantage of the present invention is that a potentially multi-functional cure plate is provided to aid in the processing of the preform or cast part being created using the apparatus of the present invention. The cure plate can be self-heating to aid in a curing or drying process. Alternatively or additionally, the cure plate can aid in the finish characteristics; final thickness achieved; overall part shape; and/or part density (especially if used as a press mechanism).

A further advantage of the present invention is that the shapes and/surface features of each of the mold plate, cure plate, and/or skirt or filter may be chosen so as to achieve any of a variety of desired product shapes, including potentially complex shapes and/or fine product details. Use of the skirt to produce such features is further advantageous in that can prove easier/less expensive to change than the main tooling (i.e., the plates).

Yet another advantage of the present invention is that the invention can be used in conjunction with a pulp molding/die-dried process. One such procedure can be felting or molding a blank from a fibrous suspension using the mold tool of the present invention. Another such procedure is drying and/or pressing of a blank using the mold tool and cure plate of the present invention.

An even further and most important advantage of the present invention is that the vacuum molding system can be used in the molding of castable material, both in creating a fibrous skirt/filter from the suspension upon which a cast or molded part may be initially formed, as well as the process of actually casting or molding the part from a suspension of particulate and/or fibrous material to thereby form a cake casting or molding.

Yet an additional advantage of the present invention is that various needs are available to control the tightness of packing of fibrous/particulate material and/or the fiber orientation within either of a cake, a filter/skirt, or molded article. Such means of manipulation may include, for example, controlling the size distribution and/or composition of the fibers or molding themselves. Alternatively or additionally, the fibrous suspension used in forming the cakes or filters/skirts may be manipulated mechanically (e.g., vibrationally), chemically (e.g., via inclusion of dispersants or other rheological agents in the suspension), magnetically, and/or electrostatically. Such manipulation can be used to achieve a random/isometric or an oriented distribution of the fibers, as desired. A most important aspect is that of manipulating the three dimensional location of the mold relative to gravity, while the mold is suspending in the pulp, slurry or suspension, thereby further controlling the lay-up or molding parameters in an enhanced manner, more than any prior molding or casting system.

An advantage stemming from the ability to manipulate fiber or molded part orientation is that a multi-layer component can be developed in which fibers are oriented in each layer so as to promote drainage therethrough and/or to achieve a desired set of product characteristics.

Secondary aspects of the cake/casing/molded article produced can be altered based upon the characteristics (e.g., shape, surface features) of the skirt/filter being used. This is important in that it can be easier and less expensive to produce a specially modified skirt than to do so with the main tooling, especially if it would dictate the need to frequently change and/or replace the main tooling.

Another advantage of the present invention, associated with the casting or molding of a given part, is that the molding tool may be used to carry the cast portion through multiple process stages/steps after the initial casting, so as to thereby reduce the chances of the failure of such a cast or molded part during such subsequent processing steps, especially if the part in question is a thin, molded component.

Yet another advantage of the present invention is that a wide range of composite/homogeneous structures can be formed of any of, for example, various sizes, shapes, and/or compositions.

An even further advantage of the present invention is that the molding/casting system of the present invention can be applied to processes such as paper making or polymer-bound matrix-composite formation, each of which essentially yield a finished product upon removal from the molding tool of the present invention, or to such processes as the near-net-shape production of green-state bodies which require a further firing or sintering step.

An additional advantage of the present invention is that the casting/molding process allows for the near-net-shape manufacturing of potentially complex components without further machining. For example, via the process of the present invention, it is possible to produce a two-inch diameter hemisphere composed of a lead zicronate titanate (PZT) material (i.e., a common piezoelectric material) so as to meet a tolerance requirement of 10/10,000 inch, without any need for further machining.

Yet an additional advantage of the present invention is that the process is flexible enough to permit the deposition of a mold or cast material around a reinforcement matrix material (e.g., carbon or Kevlar gauze) in different thicknesses via different orientations in three dimensional space, why maintaining the homogeneous nature of the molded article.

### BRIEF DESCRIPTION OF THE DRAWINGS

The features and advantages of this invention, and the manner of attaining them, will become more apparent and the invention will be better understood by reference to the following descriptions of the embodiments of the invention taken in conjunction with the accompanying drawings, wherein:

FIG. 1 is an diagrammatic perspective view of the molding system of one embodiment the present invention;

FIG. 2 is a diagrammatic perspective, partially cut-away view of the forming head of FIG. 1, shown in an alternate orientation;

FIG. 3 is a diagrammatic perspective view of an alternate embodiment of the molding system for producing various size and shape molded articles showing an alternate system of controlling the three dimensional orientation of the forming head;

The exemplifications set out herein illustrate at least one preferred embodiment of the invention, in one form, and such exemplifications are not to be construed as limiting the scope of the invention in any manner.

### DETAILED DESCRIPTION OF THE INVENTION

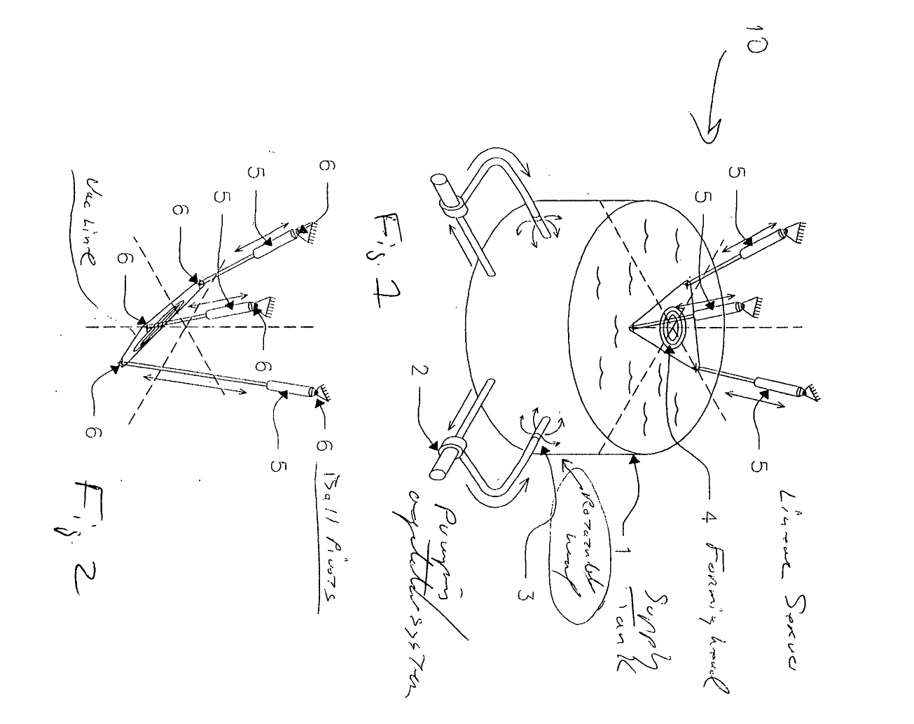

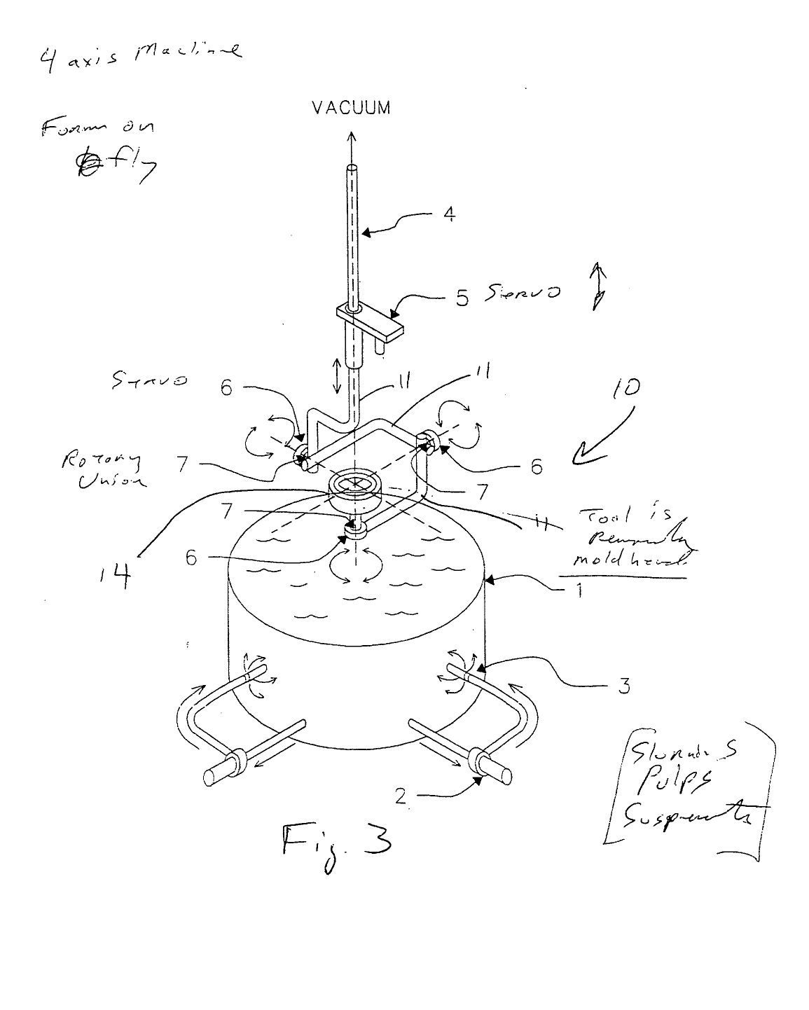

Molding System tool 10 of the present invention is illustrated in FIGS. 1, 2 and 3. Molding System 10 includes a mold forming head tool 4 (FIGS. 1-2) or 14 (FIG. 3). Molding tool components 4, or 14, are advantageously made from a material that can withstand up to 1400° F. without scaling or deforming in any manner. Some potential materials for these components are 316, 321, or 347 stainless steel; titanium; a ceramic material; and/or a high-temperature composite (e.g., ceramic/ceramic or ceramic/metal). Such a material is chosen as the tooling 4,14 needs to withstand temperatures as high as 1400° F. is so that tool 4, 14 may be fired at a relatively high temperature for the purpose of cleaning therefrom any fibrous, particulate, or binder material which may become lodged therein. After reducing such clogging/fouling waste to an ash, to the degree possible, the tool is then high-pressure washed and made ready for reuse.

Mold tool 4, 14 is located in three dimensional space by the attachment arms 5 (FIG. 1-2) comprised of linear servos or other manually or computer controllable actuating systems, that can fix and or relocate the three dimensional position of forming head 4, 14 during molding within a tank 1 of slurry, pulp, or other suspension. Tank 1 is supplied with a pumping or agitation system 2 to continuously and substantially completely maintain the homogeneousness of the pulp, slurry or suspension within tank 1 used as the constituent material for the molded article to be formed on tool 4, 15. A rotatable nozzle 3 is utilized to mix the mixture within tank 1.

Vent/drain slots (not shown) are provided in mold tool 4, 14 for the purpose of venting, pulling, and/or draining a molding or casting suspension on the tool.

Such channels or slots may be arranged co-parallel or nearly so to each other to promote uniform fluid flow through the mold face. Yet it may prove advantageous to arrange the slots in any of a variety of patterns, for example: a star-shape, a series of concentric circles, a spiral-shape, a series of nested polygons, or potentially a non-regular pattern. Any of these or other patterns may be chosen to achieve a desired fluid flow for mold tool 4, 14. While in most instances a uniform fluid flow will be desired, there may be instances in which a controlled non-uniformed fluid flow is desired to thereby specifically create variances in the surface of the cake being formed thereupon. No matter the pattern, it is generally preferable that slots be made as narrow as possible yet still able to sufficiently vent steam and/or drain the fluid (i.e., liquid or gas) portion of the molding or casting suspension therethrough.

Molding tool 10 is advantageously used as part of a molding arrangement system which further incorporates a vacuum device (4, FIG. 3). Vacuum device 4, as illustrated in FIG. 3, is connected to and may be said to include a vacuum mold forming head base tool 14, and a plurality of vacuum conduits 11, interconnected for relative articulation by rotary unions 7, allowing movement with three degrees of freedom of mold forming head 14 relative to gravity. Located at each rotary union 7 or servos 6 or other devices to accurately control the positioning of the conduits 11, which would necessarily then control the placement and orientation of mold forming head 14 in three dimensional space relative tank 1, nozzles 3, and gravity. A servo mechanism 5 is connected to vacuum source line 4, permits the assembly to be removed from the liquid or source material of tank 1 when necessary.

Additionally, it is advantageous for vacuum source 4 to be adjustable so that various molding/casting parameters can be accommodated (e.g., molding weight/density, molding complexity, durability of cake formed, and/or general ease with which a particular fluid can be drawn through mold channels (not shown). This adjustability may be computer controlled.

The embodiments of molding arrangement shown in FIGS. 1-2 illustrate the variety of complex orientations, which may be utilized in the mold or forming process of the invention. As can be seen from FIGS. 1 and 2, mold forming head 4 can be developed for movement or controlled orientation with in tank 1, thereby causing formation of thicker, shaped pieces or molding thin fragile parts, or in all cases controlling the settling of movement of the material from suspension onto the mold forming tool. By changing the effective length of adjustment members 5, tool location may be changed before, during or after molding.

FIG. 3 illustrates a system designed for locating the forming tool 14, within tank 1, such that the forming process, (in one aspect, while applying vacuum through tool 14, causing articles in suspension to build in thickness on the forming tool surface). In the embodiment of FIG. 3, servos 6 change relative locations between vacuum conduits 11, which therefore change the location of mold forming head or tool 14, within and relative to tank 1, the suspension therein, and most importantly gravity.

It is well within the scope of the present invention to create a molding arrangement for forming cylinders, domes, or other complex convoluted or irregular shapes, including, parts with raised portions and/or valleys/grooves. As a result, it is possible to use the molding arrangements system to create any of a variety of components including, but not limited to, fuel cells, piezoelectric components, audio speakers, and semiconductor components (including multi-layer devices), even more particularly complex items formed from carbon fibers or other items pulled out of suspension and formed, molded or laid-up on tool 4, 14.

Molding tool 10 and, more generally, molding arrangement 25 have at least two general processes in which they can be advantageously employed. The first type of process is a pulp molding process in which arrangement 25 is used in a standard die-dried (pulp molding) process. The second process is a method of molding or casting a form from a suspension including a chosen material to be formed. While both molding and casting are used to create a part that is a “negative” of a given mold shape, the term casting is generally used when a thicker suspension is being employed and, generally, a bulkier/thicker component is desired to be produced. The suspension for casting is generally composed of about 10%-35% solids (i.e., particulate and/or fibrous) as well as, any binders and/or additives. On the other hand, molding is the term used when a rather dilute suspension is used with the solid content advantageously being about 3% or less and preferably, on the order of 0.3%-0.10% solid. Molding may promote a more even material distribution than is possible with casting and has proven very useful in creating components having very thin sections. If not more even, the system may increase the reproducibility and consistence of the formed or molded item.

The molding procedure can, more particularly, be used with respect to two procedures associated with pulp molding. The first procedure is the felting of a paper/pulp blank where molding tool 5, 14 is covered with a suspension made up of wood pulp, a synthetic blend of fibers, and/or other types of fibers along with water and/or another suspension fluid (e.g., another liquid or, potentially, a gas). It is also to be understood that such a suspension may also include, for example, chemicals (such as dispersants) which contribute to the suspension chemistry and/or ingredients such as binders which aid characteristics of the formed felt/blank.

Upon covering molding tool 4, 14 with the desired suspension, a vacuum is applied to molding tool via vacuum device or conduits (11, FIG. 3) in order to draw the water and/or other carrying medium from the suspension, thereby resulting in the formation of a felt-like preform or material thickness on the mold surface. Molding tool 4, 14 is then removed from the suspension, and the remaining water/suspension medium is pulled from the blank via the vacuum to thereby produce a preform of a preset dryness. During the molding operation, the orientation of the forming head 4, 14 may or may not be changed in relative three dimensions within tank 1, which could lead to different material properties (e.g. thickness), among other things.

The second procedure associated with pulp molding which may incorporate molding arrangement and/or molding tool 10 is the drying and pressing of the felted blank to the final shape and dryness thereof. This procedure is accomplished by placing the damp felted blank or preform into a molding arrangement in which the molding tool 4, 14 is heated. Such heating of the mold 4,14 ay be accomplished by placing molding tool 4, 14 in a heated environment such as an oven or by bringing a heated cure plate into contact with the blank or preform. If heated cure plate is used, it can provide an element of pressure to promote drying and/or forming. The steam that is generated upon heating molding tool 10 is able to be vented through the combination of slots and channels (not shown) in mold plate 5, 14. To further aid in the venting of steam, a woven or non-woven screen material (not shown) may be provided over the slotted mold surface.

The suspension formulation used to achieve the desired filter membrane is chosen so as to get the desired suspension chemistry and rheology needed to achieve a substantially uniform distribution of the fibers both in suspension and upon precipitation thereof in such a manner so as to produce an acceptable preform in a timely fashion. Such factors as fiber material, size, and size distribution; base suspension composition and viscosity; mold shape and configuration; and vacuum characteristics can affect the generation of the filter membrane.

Depending both upon the suspension characteristics and final filter membrane characteristics desired, fibers may be chosen that are anywhere in the range of microns to centimeters in length, as required. The same general limitations will extend on to the casting or molding material suspension with the understanding that the casting or molding material may include particulate matter, instead of or in combination with fibers, with the particle size and size distribution also being a factor for consideration under such circumstances.

Upon forming and drying of the skirt if utilized, a premixed casting material is poured on, onto a skirt membrane. A leveling operation is done either by vibration cycles and/or a mechanical operation of servos 6 or linear actuators. In further conjunction, a vacuum (i.e., via vacuum source 4 for example FIG. 3) is applied to a back surface of a mold plate 4, 14, carrying the skirt and cast part on mold surface. This vacuum may be constant or cycling in nature. A cycling vacuum can be used to create a pulse wave to drive the liquid materials down through the denser material associated with the skirt and/or cast part. Such a pulse wave thereby creates paths that open and then close, thereby preventing a constant channel from being formed within either of the skirt or cast part that would later potentially cause the part to have stress cracks formed therein.

After most of the liquid is pulled from the part and a firm cake has been formed as the cast part, two potential routes may be taken. One route may be to remove the cake from the mold tool using standard die-dried operations, the cake then being pressed to shape. The other avenue which may be taken is that the tool, with the formed cake therein, may be moved to another operation such as an embossing, pre-dry/pre-cure, or shaping operation, or a combination thereof. In the case of the first option, the processing of the cast cake part that is done in conjunction with molding arrangement would be complete. This first option works very well, for example, with a product that has enough mass to it to form a cake that can be transferred to a pressing operation. However, if the part is very thin, and/or has fine details associated with it (e.g., FIG. 4), such as fuel cell plates, or has fragile ribs, such as fuel cell dryer plates, then the first process would not be an optimal choice. In the latter process option, the cake is maintained with molding arrangement 25 for at least another operation.

In pursuing the second route beyond such steps recited, the next step would be to cure the material. In this instance, mold tool may or may not be heated since a separate heating step may be separately provided for. (If mold forming plate 4,14 is heated, the provision of a cure oven to effectively heat the plate would be necessary.

In a step, a high vacuum is applied to back surface of mold plate via vacuum device 4 and all the liquid or fluid that can be removed via vacuum is done so here. Molding forming member 4, 14 and the casting carried thereby are then moved through a curing oven, that brings the tool and part up to a preset temperature. This preset temperature may be chosen so as to promote further drying and/or to initiate the curing of any binder materials within the casting. It is to be understood that the general process may be set up such that the entire molding arrangement is set up to move through the curing oven, or such that molding tool 10 along with the cast/molded part are actually moved, with each vacuum device 4 in use remaining in a fixed station location.

Molding tool 10 and the cast part carried thereby could be then transported into a non-heated press, where the part is pressed between molding tool 4, 14. This pressing operation also starts the cooling down of the tool 10 and its accompanying part.

As for the casting material, a wide variety of material compositions and material forms may be employed. The material forms can range from fine grain castable materials in particulate form to fibrous materials, as well as combinations thereof. If an essentially homogenous casting/molding is desired, a powdered/particulate form of any one of a polymer, metal, or ceramic material may be employed. However, if a composite structure is desired, a combination of particulates and/or fibers of various sizes and/or compositions may be chosen.

For example, a polymer, such as a heat-curable resin (e.g., phenolic resin), can be chosen as a matrix and/or binder system material and one or more fibrous or particulate materials composed of any one of, e.g., a glass, plastic, elastomer, carbon, silicon nitride, silicon carbide, another ceramic, or a metal can be chosen as the reinforcement material. (While a matrix and a binder can each serve to hold a composite together, a matrix material is generally considered to be substantially continuous in nature.) With such a composite, the matrix and/or binder polymer can be cured (at least about 400° F.), and the composite essentially formed into a final, workable product. Polymer-based composites tend to offer significant strength/toughness while yet providing good flexibility.

Alternatively, the system 10 can be used to create a green-state near-net shaped product. This green-state product would typically be a ceramic/ceramic, ceramic/glass, metal/ceramic, or powdered metal or ceramic, advantageously held together by a temporary binder. As a green-state product, the product generally has enough strength to be handled but requires a further thermal processing step in order to achieve full strength and/or other (e.g., thermal, electrical, optical) capabilities. The use of a curing oven may be useful in improving the intermediate strength of the green-state product if a heat-curable resin is used as a temporary binder material in the product. In any event, the completed part, if it is a green-state near-net shaped product upon completion, will then need to be fired/sintered to produce the final usable product.

The casting/molding material can actually be chosen such that the material is initially a composite but such that the end product A is instead be a porous yet homogenous structure. A method by which such a structure can be achieved is to start with a composite casting material of a polymer fiber/polymer matrix combination. In such an instance, the polymer fiber is chosen such that it (but not the matrix material) will melt or burn out upon curing of the polymer matrix material. As such, only the polymer matrix material will be left and pores will be left in the structure where the polymer fiber had existed.

It has been found that the apparatus and process of the present invention is especially useful with respect to the casting/molding to shape of very fine carbon/carbon composites. In some instances, such carbon composites may use a temporary binder system and be sintered to their final state. In others, a resin binder/matrix may be employed that is cross-linked to produce a flexible final composite part.

It is to be understood that various shapes and sizes of completed mold/cast parts can be achieved using various size and shape combinations for mold plate 4, 14 still remain within the scope of the present invention.

While not specifically shown in any of the figures, it is to be understood that multi-layer castings or moldings can be produced using the present invention to thereby achieve the desired characteristics. In such layers, the orientation of layers and mold and part formed, composition, and/or particle/fiber size distribution, by way of example only, can be varied for each of the layers. A potential use for multi-layer structures is in the area of semiconductor manufacture. For example, a semiconductor component produced in such a fashion could potentially have consecutive layers of carbon, a semiconductor material, silver, carbon, etc.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

1. A molding tool system comprising:
at least one container for holding material to be molded;
a mold tool on which material is be molded; and
locating means associated with the mold tool to position said mold tool within said at least one container.

2. The molding tool system of claim 1 in which said at least one container holds at least one of a pulp, slurry or suspension mixture.

3. The molding tool system of claim 1 further comprising a vacuum means associated with said mold tool to draw material through said mold tool.

4. The molding tool system of claim 3 in which said vacuum means includes at least one rotary union, such that vacuum pressure may be applied to said mold tool while said mold tool is in different positions with said container.

5. The molding tool system of claim 4 in which said vacuum means varies the vacuum pressure applied to said mold tool during the molding operation.

6. The molding tool system of claim 1 in which said locating means varies the position of said mold tool with said container during the molding process.

7. The molding tool system of claim 1 in which said locating means includes servos for moving said mold tool.

8. The molding tool system of claim 1 in which said locating means includes linear servos for moving said mold tool within said container.

9. The molding tool system of claim 1 including a means for controlling the locating means to vary the orientation of said mold tool in said material.

10. A molding method comprising the steps of:
providing a container for holding the material to be molded;
disposing a molding tool, having passages therethrough, in to the material;
applying vacuum pressure through said passages to draw material through said molding tool and create a molded workpiece on said molding tool.

11. The method of claim 10 further including the step of varying the orientation of the molding tool with in the material during molding.

12. The method of claim 10 further including the step of varying the orientation of the molding tool within the material during the application of vacuum pressure.

13. The method of claim 10 further including the step of providing differing materials to be molded about the molding tool, thereby creating different material layers in the molded workpiece.
